(19) United States
(12) Patent Application Publication
(10) Pub. No.: US 2025/0173136 A1
(43) Pub. Date: May 29, 2025

(54) CONTROL DEVICE, CONTROL METHOD, AND NON-TRANSITORY STORAGE MEDIUM

(71) Applicant: TOYOTA JIDOSHA KABUSHIKI KAISHA, Toyota-shi (JP)

(72) Inventor: Katsuhiro Masuda, Ibi-gun (JP)

(73) Assignee: TOYOTA JIDOSHA KABUSHIKI KAISHA, Toyota-shi (JP)

(21) Appl. No.: 18/920,241

(22) Filed: Oct. 18, 2024

(30) Foreign Application Priority Data
Nov. 29, 2023 (JP) 2023-201727

(51) Int. Cl. G06F 8/65

(52) U.S. Cl. CPC G06F 8/65

(57) ABSTRACT

A control device is configured to control a display unit configured to display information on software update for an in-vehicle device mounted on a vehicle. The control device includes a circuitry configured to cause the display unit to display first information and second information while an activation process for enabling update software installed in the in-vehicle device is being performed in response to switching of power of the vehicle from ON to OFF. The first information indicates progress of the activation process. The second information indicates that the power is not switchable from OFF to ON.

### CROSS-REFERENCE TO RELATED APPLICATION

This application claims priority to Japanese Patent Application No. 2023-201727 filed on Nov. 29, 2023, incorporated herein by reference in its entirety.

### BACKGROUND

### 1. Technical Field

The present disclosure relates to a control device, a control method, and a non-transitory storage medium.

### 2. Description of Related Art

Vehicles include various in-vehicle devices that operate through execution of software. There is known an over-the-air (OTA) technology in which software of an in-vehicle device is updated using software downloaded from outside a vehicle by wireless communication. As described in Japanese Unexamined Patent Application Publication No. 2022-163396 (JP 2022-163396 A), software update is performed through an installation process in which downloaded update software is written to a storage module of an in-vehicle device, and an activation process in which the installed update software is enabled.

### SUMMARY

The activation process may be performed while the vehicle is powered OFF. In such a case, the vehicle cannot be powered ON again during a period from the start to the completion of the activation process. During such a period, the vehicle cannot receive a power-ON operation, which may cause a user to suspect a malfunction, or the like.

A control device according to an embodiment of the present disclosure is configured to control a display unit configured to display information on software update for an in-vehicle device mounted on a vehicle. The control device includes a circuitry configured to cause the display unit to display first information and second information while an activation process for enabling update software installed in the in-vehicle device is being performed in response to switching of power of the vehicle from ON to OFF. The first information indicates progress of the activation process. The second information indicates that the power is not switchable from OFF to ON.

The circuitry may be configured to cause the display unit to display the first information and the second information in response to a start of the activation process.

The circuitry may be configured to cause the display unit to display the first information and the second information in response to a predetermined operation by a user of the vehicle in which the activation process is being performed.

The circuitry may be configured to cause the display unit to display the second information in response to a start of the activation process, and cause the display unit to display the first information in response to a predetermined operation by a user of the vehicle in which the activation process is being performed.

The circuitry may be configured to switch the information displayed on the display unit from the first information and the second information to third information in response to completion of the activation process. The third information indicates that the activation process has been completed.

The vehicle may include a plurality of the in-vehicle devices. The circuitry may be configured to, when the activation process is performed for the plurality of the in-vehicle devices in response to the switching of the power of the vehicle from ON to OFF, switch the information displayed on the display unit from the first information and the second information to the third information in response to completion of the activation process for all of the plurality of the in-vehicle devices.

The vehicle may include a plurality of the in-vehicle devices. The control device may be one of the plurality of the in-vehicle devices. The circuitry may be configured to, when the activation process is performed for the plurality of the in-vehicle devices including the control device in response to the switching of the power of the vehicle from ON to OFF, switch the information displayed on the display unit from the first information and the second information to the third information in response to completion of the activation process for all of the plurality of the in-vehicle devices including the control device.

The control device may be the in-vehicle device in which the activation process is performed.

The control device may be mounted on the vehicle. The circuitry may be configured to cause the display unit to display the first information and the second information while the activation process is being performed for another of the in-vehicle devices mounted on the vehicle.

The control device may be a server device independent of the vehicle.

The display unit may be mounted on the vehicle.

The display unit may be an information terminal independent of the vehicle.

The first information may include an estimated period required until the activation process is completed.

A control method according to an embodiment of the present disclosure is a control method for a display unit configured to display information on software update for an in-vehicle device mounted on a vehicle. The control method includes causing the display unit to display first information and second information while an activation process for enabling update software installed in the in-vehicle device is being performed in response to switching of power of the vehicle from ON to OFF. The first information indicates progress of the activation process. The second information indicates that the power is not switchable from OFF to ON.

A program according to an embodiment of the present disclosure is to be executed by a control device configured to control a display unit configured to display information on software update for an in-vehicle device mounted on a vehicle. The program includes causing the control device to perform a process of causing the display unit to display first information and second information while an activation process for enabling update software installed in the in-vehicle device is being performed in response to switching of power of the vehicle from ON to OFF. The first information indicates progress of the activation process. The second information indicates that the power is not switchable from OFF to ON.

A non-transitory storage medium according to an embodiment of the present disclosure, the non-transitory storage medium storing instructions that are executable by one or more processors and that cause the one or more processors to perform functions comprising:
controlling a display unit configured to display information on software update for an in-vehicle device mounted on a vehicle; and
performing a process of causing the display unit to display first information and second information while an activation process for enabling update software installed in the in-vehicle device is being performed in response to switching of power of the vehicle from ON to OFF, the first information indicating progress of the activation process, the second information indicating that the power is not switchable from OFF to ON.

The control device has an effect of improving user convenience.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 schematically shows the configurations of a control device and a vehicle according to a first embodiment;

FIG. 2 is a sequence diagram showing the flow of an activation phase process when software update is performed by a first update procedure in the first embodiment;

FIG. 3 shows an example of an informational image displayed by the control device of the first embodiment;

FIG. 4 shows an example of a completion image displayed by the control device of the first embodiment;

FIG. 5 is a sequence diagram showing the flow of a process related to a check on the progress of software update on an information terminal in a second embodiment;

FIG. 6 shows another display example of second information; and

FIG. 7 shows another display example of first information.

### DETAILED DESCRIPTION OF EMBODIMENTS

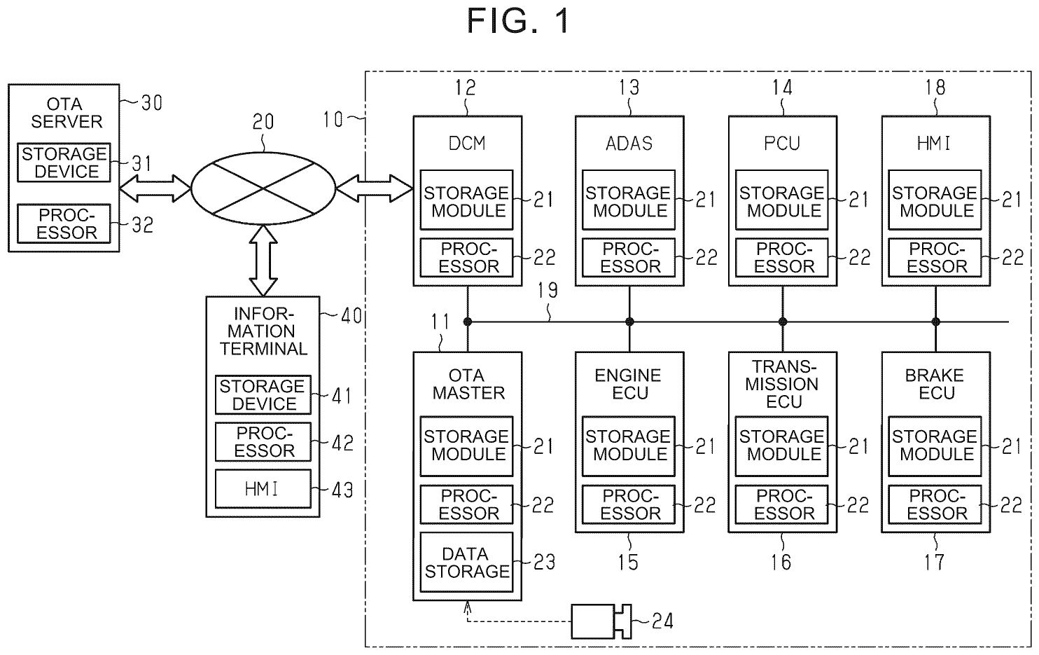

Hereinafter, a control device, a vehicle, a control method, a non-transitory storage medium and a program according to a first embodiment will be described in detail with reference to FIGS. 1 to 4.

### Configurations of Control Device and Vehicle

As shown in FIG. 1, a vehicle 10 includes in-vehicle devices such as an OTA master 11, a DCM 12, an ADAS 13, a PCU 14, an engine ECU 15, a transmission ECU 16, a brake ECU 17, and an HMI 18. These in-vehicle devices are connected to each other via an in-vehicle network 19 to communicate with each other. The OTA master 11 manages software update of the in-vehicle devices including the OTA master 11 itself. The DCM 12 is a data communication module and provides a function of wireless communication with the outside of the vehicle via a mobile communication network 20. In the present embodiment, the DCM 12 has a function of recording results of self-diagnosis performed by the in-vehicle devices of the vehicle 10 and transmitting the results to a data center etc. outside the vehicle. The ADAS 13 is an advanced driving assistant system and provides advanced driving assistant functions such as an automatic braking device and a sudden acceleration prevention device. The PCU 14 is a power control unit and is an in-vehicle device that performs power control inside the vehicle. The engine ECU 15 is an electronic control unit for controlling an engine. The transmission ECU 16 is an electronic control unit for controlling a transmission. The brake ECU 17 is an electronic control unit for controlling brakes. The HMI 18 is a human-machine interface and includes an input device that receives operations by occupants and a display device that displays information for the occupants using images and audio. The HMI 18 may have a navigation function for providing route guidance and an entertainment function for playing music and videos. Each of these in-vehicle devices includes a storage module 21 that stores software, and a processor 22 that executes the software. The OTA master 11 further includes a data storage 23 that stores update software acquired from outside the vehicle.

The vehicle 10 includes a power switch 24 for switching the power of the vehicle 10 between ON and OFF. The drive system of the vehicle 10 starts in response to switching from power OFF to power ON, and stops in response to switching from power ON to power OFF.

The vehicle 10 is connected to an OTA server 30 via the mobile communication network 20. The OTA server 30 is a server device that distributes update software for in-vehicle devices. The OTA server 30 includes a storage device 31 that stores programs and data for distributing update software, and a processor 32 that executes the programs for distribution.

The OTA server 30 can communicate with an information terminal 40 of a user of the vehicle 10 via the mobile communication network 20. Examples of the information terminal 40 include a smartphone. The information terminal 40 includes a storage device 41, a processor 42, and an HMI 43. The processor 42 reads and executes software stored in the storage device 41. The HMI 43 includes an input device that receives operations by the user and a display device that displays information for the user. The software stored in the storage device 41 includes software that provides functions such as information checking about the vehicle 10 owned by the user and remote control on the vehicle 10.

### Overview of Software Update

Next, an overview of software update for the in-vehicle devices of the vehicle 10 will be described. The in-vehicle devices to be subjected to software updates include the OTA master 11, the DCM 12, the ADAS 13, the PCU 14, the engine ECU 15, the transmission ECU 16, the brake ECU 17, and the HMI 18. The software update proceeds through a download phase, an installation phase, and an activation phase.

In the download phase, update software is transmitted from the OTA server 30 to the vehicle 10. The OTA master 11 stores the update software received from the OTA server 30 in the data storage 23. The download phase includes a series of processes related to download, such as determination as to whether download can be performed and verification of update data. The transmission of the update software from the OTA server 30 to the OTA master 11 may include transmission of compressed data obtained by compressing the update software, transmission of divided data obtained by dividing the update software or the compressed data, or collective transmission of pieces of update software for a plurality of in-vehicle devices.

In the installation phase, the update software is installed in the update target in-vehicle device. In the installation phase, the OTA master 11 writes the update software to the storage module 21 of the update target in-vehicle device. The installation phase includes a series of processes related to installation, such as determination as to whether installation can be performed, transfer of the update data, and verification of the update software. When the update data includes the update software, the OTA master 11 transfers the update data to the update target in-vehicle device in the installation phase. When the update data includes compressed data, difference data, or divided data of the update software, a process of generating the update software from the update data is performed. The generating process may be performed by the OTA master 11 or by the update target in-vehicle device. The update software can be generated by decompressing the compressed data or assembling the difference data or the divided data. When the installation phase is completed, the update software is disabled.

In the activation phase, the update software is activated, that is, enabled, in the update target in-vehicle device. The activation phase includes a series of processes related to activation, such as determination as to whether activation can be performed, a check on the compatibility of the updated software, and verification of the result of the activation.

### Two Software Update Procedures

There are two procedures that are a first update procedure and a second update procedure as the software update procedure for the in-vehicle device. In both the first update procedure and the second update procedure, the software update is performed by a common procedure up until the completion of the installation phase. The first update procedure and the second update procedure differ in terms of the timing to start the activation process for enabling the updated software in the activation phase. In the first update procedure, the activation process is started in response to switching of the power of the vehicle 10 from ON to OFF. When the software update is performed by the first update procedure, the vehicle 10 is prohibited from being powered ON again until the activation process is completed. In the second update procedure, the activation process is started in response to switching of the power of the vehicle 10 from OFF to ON. The update target in-vehicle device at this time starts operating through the wait for completion of the activation process after the power of the vehicle 10 has been switched from OFF to ON. The method for performing the software update by either the first update procedure or the second update procedure is determined based on, for example, the type of in-vehicle device, the hardware configuration, and the type of software.

When performing the software update by the first update procedure, electric power needs to be supplied to the in-vehicle device undergoing the activation process even while the vehicle 10 is powered OFF. Therefore, the in-vehicle device that undergoes the software update by the first update procedure needs to be connected to a dedicated power line for supplying electric power while the vehicle 10 is powered OFF. Thus, it is desirable to basically perform the software update for the in-vehicle device by the second update procedure that does not need the dedicated power line.

When the activation process is performed in the software update by the second update procedure, however, the update target in-vehicle device cannot start operating during the period from the switching of the power of the vehicle 10 from OFF to ON to the completion of the activation process. When the activation process is performed in the software update by the first update procedure, the activation process has already been completed at the timing of switching of the power of the vehicle 10 from OFF to ON. In this case, the update target in-vehicle device can start operating immediately after the power of the vehicle 10 is switched from OFF to ON. Therefore, it is desirable to perform the software update by the first update procedure for an in-vehicle device required to start operating immediately after the power of the vehicle 10 is switched from OFF to ON.

In the present embodiment, the DCM 12, the ADAS 13, and the PCU 14 are classified as in-vehicle devices that undergo the software update by the first update procedure. The communication function provided by the DCM 12 is used to report an abnormality of the vehicle 10 to the outside. In the present embodiment, the DCM 12 records results of self-diagnosis of the in-vehicle devices. The ADAS 13 needs to perform driving assistance from the time when the vehicle 10 starts traveling. While the operation of the PCU 14 is stopped, electric power cannot be supplied to the drive system, and therefore the vehicle 10 cannot start traveling. Thus, the DCM 12, the ADAS 13, and the PCU 14 are the in-vehicle devices required to start operating immediately after the power of the vehicle 10 is switched from OFF to ON.

The software update by the first update procedure may be required also depending on the hardware configuration of the storage module 21 mounted on the in-vehicle device. In the present embodiment, among the in-vehicle devices other than the DCM 12, the ADAS 13, and the PCU 14, in-vehicle devices including single-bank storage modules 21 are classified as the in-vehicle devices that undergo the software update by the first update procedure. Among the in-vehicle devices other than the DCM 12, the ADAS 13, and the PCU 14, in-vehicle devices including dual-bank storage modules 21 are classified as the in-vehicle devices that undergo the software update by the second update procedure.

The single-bank storage module 21 includes only one storage area for storing software to be executed by the processor 22. In such an in-vehicle device, the updated software is installed in the same storage area as the storage area that stores the pre-update software. Therefore, the operation of the in-vehicle device needs to be stopped during the installation as well. If the activation fails, recovery requires reinstallation of the pre-update software in the storage area, which takes a long period. If the pre-update software is not backed up, the pre-update software needs to be downloaded again. Thus, the in-vehicle device including the single-bank storage module 21 may require a very long period from the start of the activation to the start of the operation in consideration of the recovery in the event of failure. In the present embodiment, the in-vehicle device including the single-bank storage module 21 undergoes the software update by the first update procedure.

The dual-bank storage module 21 includes two storage areas. One of the two storage areas is inactive and the other is active. The processor 22 reads and executes the software in the active storage area. In such an in-vehicle device, the updated software is installed in the inactive storage area, that is, the storage area different from the storage area that stores the pre-update software. After the installation, activation is performed by switching the active storage area. If the activation fails, recovery to the state before the update can be achieved in a short period by switching the active storage area again. The in-vehicle device including the dual-bank storage module 21 does not require a very long period from the start of the activation to the start of the operation even in consideration of the recovery in the event of failure. For this reason, in the present embodiment, the software update by the second update procedure is performed only for the in-vehicle devices including the dual-bank storage modules 21.

A plurality of pieces of software that provides different functions may be installed in many in-vehicle devices. These pieces of software may include software that needs to be executed immediately after the vehicle 10 is powered ON, and software that need not be executed immediately. In the case of software that needs to be executed immediately after the vehicle 10 is powered ON, there is a possibility that the software will not be executed in time after the power ON if the software is updated by the second update procedure. Therefore, even the same in-vehicle device may be updated selectively by either the first update procedure or the second update procedure depending on the type of software to be updated.

The in-vehicle devices that undergo the software update by the first update procedure may include other in-vehicle devices. For example, the OTA master 11 may be included in the in-vehicle devices that undergo the software update by the first update procedure. It is assumed that the activation process is performed in a plurality of in-vehicle devices including the OTA master 11 in response to switching of the power of the vehicle 10 from OFF to ON. The OTA master 11 manages the software update of the devices other than the OTA master 11 itself. Therefore, when the OTA master 11 cannot perform the management due to its activation process, there is a possibility that the activation process for the other in-vehicle devices cannot be performed. In such a case, the activation process for the OTA master 11 and the activation process for the other in-vehicle devices need to be performed at different timings. It is desirable to perform the activation process for the OTA master 11 while the vehicle 10 is powered OFF so that a sufficient period can be secured easily.

### Activation Process by First Update Procedure

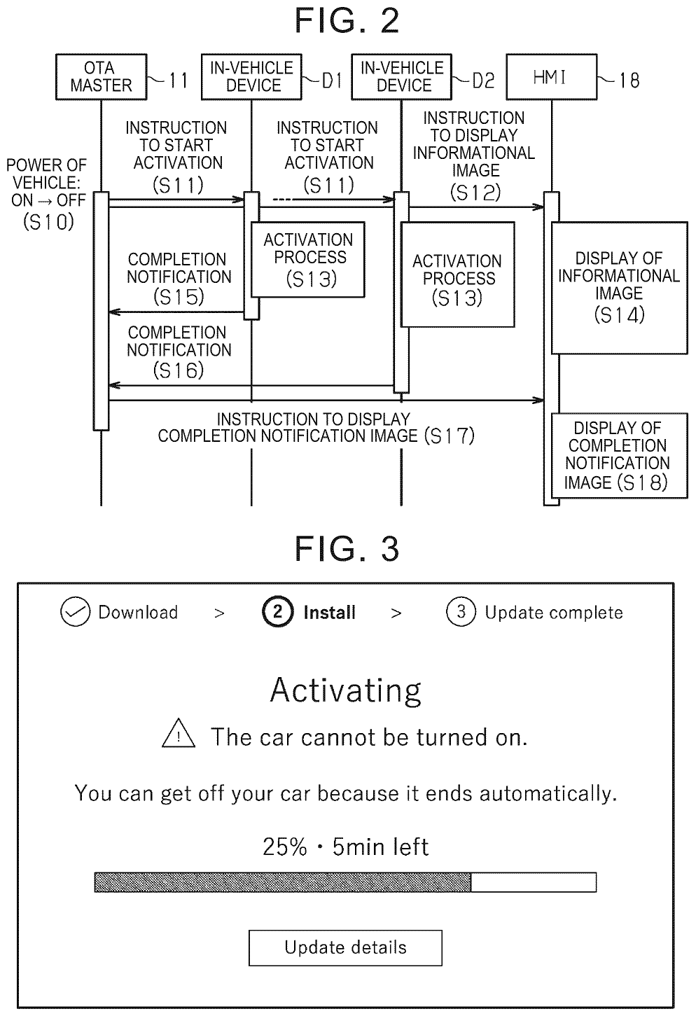

Next, the activation process to be performed by the first update procedure in response to switching of the power of the vehicle 10 from ON to OFF will be described in detail with reference to FIGS. 2 to 5. The storage module 21 of the OTA master 11 stores a program for managing the software update and a program for controlling the display of information on the software update. The OTA master 11 performs the activation process by executing these programs.

When the installation phase is completed, the OTA master 11 inquires of the user of the vehicle 10 whether to perform the activation process. The inquiry to the user is made via the HMI 18 mounted on the vehicle 10 or the user's information terminal 40. When the OTA master 11 confirms that the user has permitted the execution of the activation process, the OTA master 11 starts the activation process in response to switching of the power of the vehicle 10 from ON to OFF. Hereinafter, the state in which the installation phase is completed and the user has permitted the activation process will be referred to as a state in which the preparation for the activation process is completed.

FIG. 2 shows the flow of an activation phase process when the software update is performed by the first update procedure. FIG. 2 shows a case where pieces of software of two in-vehicle devices D1, D2 are updated by the first update procedure.

When the power of the vehicle 10 is switched from ON to OFF in the state in which the preparation for the activation process is completed (S10), the OTA master 11 instructs the in-vehicle devices D1, D2 to start the activation process (S11). In response to the instruction, the in-vehicle devices D1, D2 each start the activation process (S13). At this time, the OTA master 11 instructs the HMI 18 to display an informational image (S12). In response to the instruction, the HMI 18 displays the informational image (S14).

FIG. 3 shows a display example of the informational image. The informational image shows first information indicating the progress of the activation process, and second information indicating that the power of the vehicle 10 cannot be switched from OFF to ON. In FIG. 3, a progress percentage of the activation process and an estimated period required until the activation process is completed are displayed as the first information. In FIG. 3, a progress bar indicating the progress percentage of the activation process in the form of a graph is also displayed as the first information. The informational image shows an operation button for checking detailed information on the software update. When the user operates this operation button, the HMI 18 displays an image showing information such as the type and version of the update software and functions to be added by the update.

When occupants get out of the vehicle 10 and the doors etc. are locked, the HMI 18 turns OFF the screen and stops displaying the informational image. When the vehicle 10 is unlocked, the HMI 18 resumes displaying the informational image.

When the in-vehicle devices D1, D2 complete the activation process, the in-vehicle devices D1, D2 transmit completion notifications to the OTA master 11 (S15, S16). In FIG. 2, the in-vehicle device D1 transmits the completion notification first (S15), and then the in-vehicle device D2 transmits the completion notification (S16). When the OTA master 11 confirms that the activation process has been completed for both the in-vehicle devices D1, D2 that have undergone the activation process in response to the current power-OFF of the vehicle 10, the OTA master 11 instructs the HMI 18 to display a completion image (S17). In response to the instruction, the HMI 18 displays the completion image (S18).

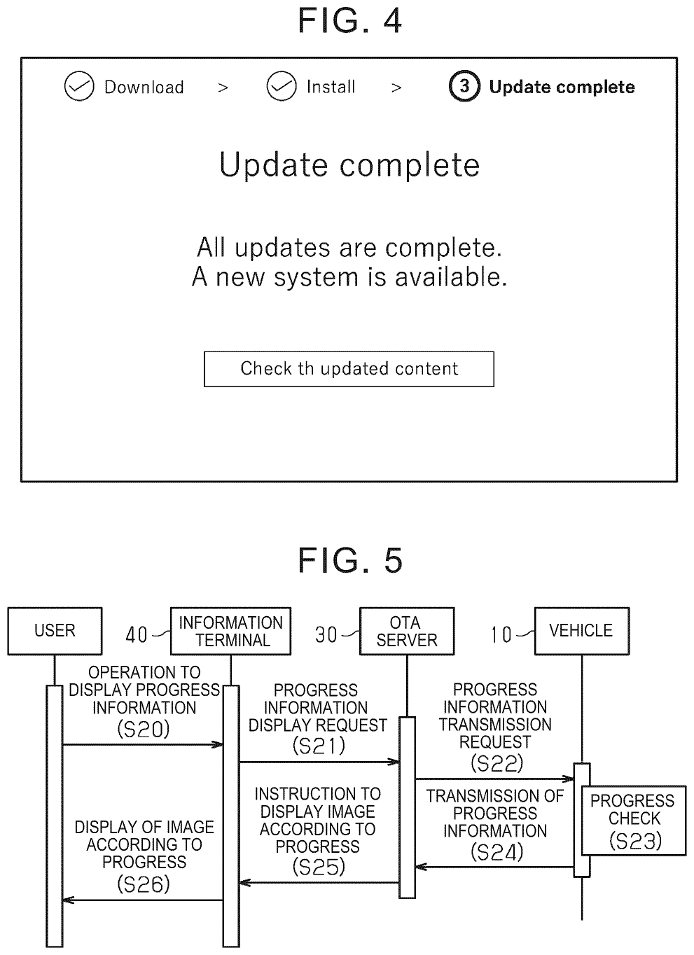

FIG. 4 shows a display example of the completion image. The completion image shows third information indicating that the activation process has been completed. In the present embodiment, the software update is completed in response to the completion of the activation process. Therefore, the third information in the completion image in FIG. 4 is displayed as a message indicating that the software update has been completed. The completion image in FIG. 4 shows notification information indicating that the updated functions of the in-vehicle device are available, and an operation button for checking detailed information on the software update.

### Check on Progress of Software Update on Information Terminal

As described above, the software that provides functions such as information checking about the vehicle 10 owned by the user and remote control on the vehicle 10 is installed in the user's information terminal 40. This software has the function of checking the progress of the software update for the in-vehicle device.

FIG. 5 shows the flow of a process related to the check on the progress of the software update on the information terminal 40. When the user performs an operation to check the progress of the software update on the information terminal 40 (S20), the information terminal 40 transmits a progress information display request to the OTA server 30 (S21). In response to the display request, the OTA server 30 requests the user's vehicle 10 to transmit progress information (S22). In the vehicle 10, the OTA master 11 checks the progress of the software update for the in-vehicle device (S23), and transmits the progress information to the OTA server 30 (S24). The progress information includes information indicating a phase of the software update being performed on the vehicle 10, a progress percentage of a process in that phase, an estimated period required until the process in that phase is completed, etc. When the OTA server 30 receives the progress information from the vehicle 10, the OTA server 30 instructs the information terminal 40 to display an image according to the progress. In response to the instruction, the information terminal 40 displays an image showing the progress of the software update (S26).

When the progress information received from the vehicle 10 indicates that the activation process is being performed, the OTA server 30 instructs the information terminal 40 to display the informational image. The content of the informational image displayed on the information terminal 40 is similar to that of the image in FIG. 3 displayed on the HMI 18 of the vehicle 10. Therefore, the informational image displayed on the information terminal 40 shows the first information indicating the progress of the activation process, and the second information indicating that the power of the vehicle 10 cannot be switched from OFF to ON.

When the progress information received from the vehicle 10 indicates that the activation process has been completed, the OTA server 30 instructs the information terminal 40 to display a completion notification image. The content of the completion notification image displayed on the information terminal 40 is similar to that of the image in FIG. 4 displayed on the HMI 18 of the vehicle 10. Therefore, the completion image displayed on the information terminal 40 shows the third information indicating that the activation process has been completed.

### Functions and Effects of Embodiment

The OTA master 11 controls the HMI 18 that displays information on the software update for the in-vehicle device mounted on the vehicle 10. When the activation process for the in-vehicle device is performed in response to switching of the power of the vehicle 10 from ON to OFF, the OTA master 11 causes the HMI 18 to display the informational image. The informational image shows the first information indicating the progress of the activation process, and the second information indicating that the power of the vehicle 10 cannot be switched from OFF to ON. When the activation process for the in-vehicle device is being performed in the vehicle 10 during the power OFF, the OTA server 30 causes the information terminal 40 to display the first information and the second information in response to a predetermined user's operation on the information terminal 40.

When the activation process is performed in response to the switching of the power of the vehicle 10 from ON to OFF, the power of the vehicle 10 cannot be switched from OFF to ON until the activation process is completed. In the present embodiment, when the activation process is started in response to the power OFF of the vehicle 10, the first information and the second information are displayed on the HMI 18 or the information terminal 40. Based on the second information, the user can confirm that the power of the vehicle 10 cannot be switched from OFF to ON. Based on the first information, the user can grasp the timing at which the activation process is completed and the power of the vehicle 10 can be switched from OFF to ON.

The control device, the vehicle, the control method, a non-transitory storage medium and the program according to the present embodiment can achieve the following effects.

The OTA master 11 causes the HMI 18 to display the informational image during the execution of the activation process when the software update is performed by the first update procedure. The OTA server 30 causes the user's information terminal 40 to display a similar informational image during the execution of the activation process when the software update is performed by the first update procedure. The informational image shows the first information indicating the progress of the activation process, and the second information indicating that the vehicle 10 cannot be powered ON. By viewing the informational image, the user can confirm that the power of the vehicle 10 cannot be switched ON due to the activation process, and an approximate period required until this state ends. Therefore, the present embodiment has an effect of improving user convenience.

The OTA master 11 causes the HMI 18 to display the first information and the second information in response to the start of the activation process. Therefore, the user can check the first information and the second information immediately after the activation process is started.

When the vehicle 10 is locked and the occupants get out of the vehicle after the activation process is started, the HMI 18 turns OFF the screen and temporarily stops displaying the first information and the second information. The OTA master 11 causes the HMI 18 to display the first information and the second information again in response to a predetermined user's operation. Therefore, the user can check the first information and the second information at any time by performing the predetermined operation on the vehicle 10.

The OTA master 11 causes the HMI 18 to display the first information and the second information in response to a user's operation along with getting into the vehicle 10, such as unlocking of the vehicle 10. Therefore, the user can check the first information and the second information when getting into the vehicle.

The OTA server 30 causes the information terminal 40 to display the first information and the second information in response to the predetermined user's operation on the information terminal 40. Therefore, the user can check the first information and the second information at any time.

When the activation process is completed, the OTA master 11 or the OTA server 30 switches the image displayed on the HMI 18 or the information terminal 40 from the informational image to the completion notification image. The completion notification image shows the third information indicating that the activation process has been completed. Therefore, in response to the completion of the activation process, the information displayed on the HMI 18 or the information terminal 40 is switched from the first information and the second information to the third information indicating that the activation process has been completed. Thus, the user can confirm that the activation process has been completed.

The activation process may be performed in a plurality of in-vehicle devices in response to switching of the power of the vehicle 10 from ON to OFF. In such a case, the power of the vehicle 10 remains unswitchable to ON while the activation process for any in-vehicle device has not been completed even though the activation process for part of the in-vehicle devices has been completed. When the activation process is completed for all the in-vehicle devices that have undergone the activation process, the OTA master 11 switches the information displayed on the HMI 18 from the first information and the second information to the third information. Thus, the user can confirm that the power of the vehicle 10 can be switched ON.

The OTA master 11 and the OTA server 30 cause the first information to be displayed on the HMI 18 and the information terminal 40 to include an estimated period required until the activation process is completed. Thus, the user can easily know the timing at which the activation process is completed and the power of the vehicle 10 can be switched ON.

In the present embodiment, the HMI 18 mounted on the vehicle 10 and the user's information terminal 40 are examples of a display unit configured to display information on software update. The HMI 18 is an example of a display unit mounted on the vehicle 10, and the information terminal 40 is an example of a display unit independent of the vehicle 10. Regarding the information display on the HMI 18, the OTA master 11 mounted on the vehicle 10 is an example of a control device configured to control the display unit. Regarding the information display on the information terminal 40, the OTA server 30 is an example of the control device configured to control the display unit. The OTA server 30 is an example of a server device independent of the vehicle 10.

### OTHER EMBODIMENTS

The above embodiment can be modified as follows. The above embodiment and the following modifications can be combined as long as no technical contradiction arises.

### Information Display Format

In the above embodiment, both the first information and the second information are displayed in the same image, but the two pieces of information may be displayed separately. In this case, it is desirable to present to the user the second information indicating that the power of the vehicle 10 cannot be switched from OFF to ON with priority over the first information indicating the progress of the activation process. For example, the second information may be displayed on the display unit in response to the start of the activation process, and the first information may be displayed on the display unit in response to a user's predetermined operation during the execution of the activation process.

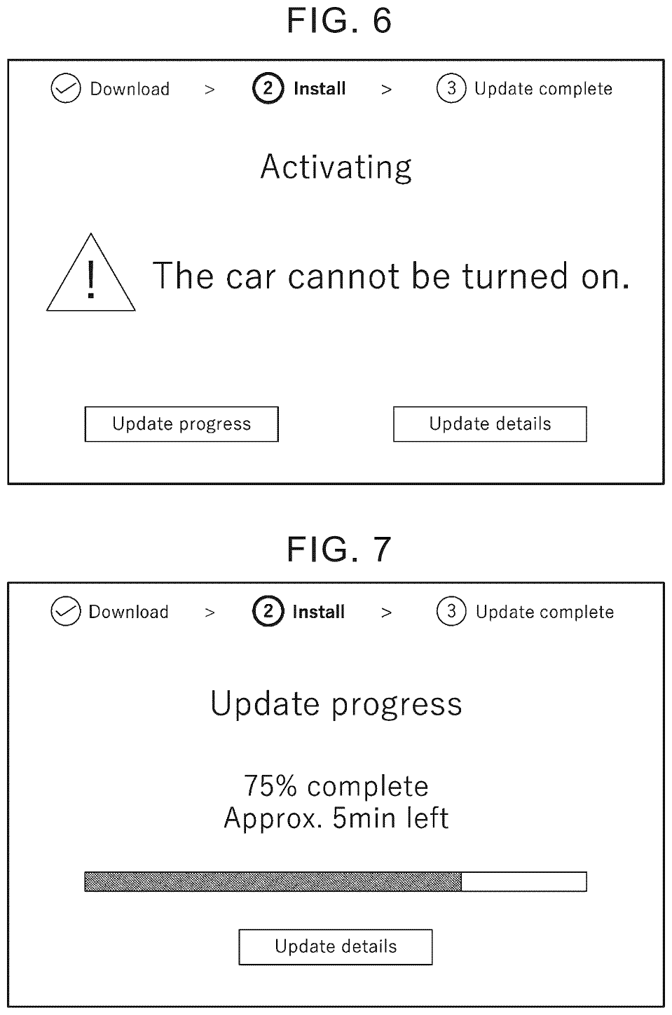

FIG. 6 shows a display example of an image showing the second information on the HMI 18. The image in FIG. 6 shows, as a text, the second information indicating that the power of the vehicle 10 cannot be switched from OFF to ON. The image in FIG. 6 shows a button for checking the progress of the software update. In response to a user's operation on the button, the OTA master 11 switches the image displayed on the HMI 18 from the image showing the second information to an image showing the first information.

FIG. 7 shows a display example of the image showing the first information on the HMI 18. The image in FIG. 7 shows, as the first information, a numerical value indicating the progress percentage of the activation process and a numerical value indicating the estimated period required until the activation process is completed. The image in FIG. 7 also shows, as the first information, a progress bar indicating the progress percentage of the activation process in the form of a graph.

The display format of information in each image in the above embodiment may be changed as appropriate. For example, only either of the progress percentage of the activation process and the estimated period to the completion of the activation process may be displayed as the first information. An estimated time of the completion of the activation process may be displayed as the first information. The first information, the second information, and the third information may be displayed using other representation methods such as still images or moving images.

### Other Modifications

The display of the third information in response to the completion of the activation process in the above embodiment may be omitted.

In FIG. 5, the OTA server 30 instructs the information terminal 40 to display the image showing the progress of the software update in response to the request from the information terminal 40. The image showing the progress on the information terminal 40 may be displayed without the request from the information terminal 40. In this case, the OTA server 30 acquires the progress information from the vehicle 10 and instructs the information terminal 40 to display an image according to the progress of the software update based on the acquired progress information.

The display control on the HMI 18 of the vehicle 10 may be performed by the OTA server 30.

The display control on the information terminal 40 may be performed by the OTA master 11.

The information on the software update may be displayed only on either the HMI 18 of the vehicle 10 or the information terminal 40.

The in-vehicle device that is the target of the software update may control the display of the information on the software update.

The OTA master 11 that manages the software update controls the display of the information on the software update. The management of the software update and the display control on the information on the software update may be performed by another in-vehicle device.

The control device of the present disclosure may include, for display control, a circuitry including one or more processors that operate according to a computer program, one or more dedicated hardware circuits such as dedicated hardware that performs at least part of various processes, or a combination thereof. Examples of the dedicated hardware include an application-specific integrated circuit (ASIC). The processor includes a central processing unit (CPU) and a memory such as a random access memory (RAM) and a read only memory (ROM). The memory stores program codes or instructions configured to cause the CPU to perform processes. The memory, that is, a storage medium, includes any available media that can be accessed by a general purpose or special purpose computer. The control device of the present disclosure may include one, two, or more memories.

### APPENDICES

[Appendix 1] A control device configured to control a display unit configured to display information on software update for an in-vehicle device mounted on a vehicle, the control device being configured to cause the display unit to display first information and second information while an activation process for enabling update software installed in the in-vehicle device is being performed in response to switching of power of the vehicle from ON to OFF, the first information indicating progress of the activation process, the second information indicating that the power is not switchable from OFF to ON.

[Appendix 2] The control device according to [Appendix 1], in which the control device is configured to cause the display unit to display the first information and the second information in response to a start of the activation process.

[Appendix 3] The control device according to [Appendix 1] or [Appendix 2], in which the control device is configured to cause the display unit to display the first information and the second information in response to a predetermined operation by a user of the vehicle in which the activation process is being performed.

[Appendix 4] The control device according to any one of [Appendix 1] to [Appendix 3], in which the control device is configured to cause the display unit to display the second information in response to a start of the activation process, and cause the display unit to display the first information in response to a predetermined operation by a user of the vehicle in which the activation process is being performed.

[Appendix 5] The control device according to any one of [Appendix 1] to [Appendix 4], in which the control device is configured to switch the information displayed on the display unit from the first information and the second information to third information in response to completion of the activation process, the third information indicating that the activation process has been completed.

[Appendix 6] The control device according to [Appendix 5], in which the control device is configured to, when the activation process is performed for a plurality of the in-vehicle devices in response to the switching of the power of the vehicle from ON to OFF, switch the information displayed on the display unit from the first information and the second information to the third information in response to completion of the activation process for all the in-vehicle devices.

[Appendix 7] The control device according to [Appendix 5] or [Appendix 6], in which: the control device is one of the in-vehicle devices; and the control device is configured to, when the activation process is performed for a plurality of the in-vehicle devices including the control device in response to the switching of the power of the vehicle from ON to OFF, switch the information displayed on the display unit from the first information and the second information to the third information in response to completion of the activation process for all the in-vehicle devices.

[Appendix 8] The control device according to any one of [Appendix 1] to [Appendix 7], in which the control device is the in-vehicle device in which the activation process is performed.

[Appendix 9] The control device according to any one of [Appendix 1] to [Appendix 8], in which the control device is mounted on the vehicle, and is configured to cause the display unit to display the first information and the second information while the activation process is being performed for another of the in-vehicle devices mounted on the vehicle.

[Appendix 10] The control device according to any one of [Appendix 1] to [Appendix 6], in which the control device is a server device independent of the vehicle.

[Appendix 11] The control device according to any one of [Appendix 1] to [Appendix 10], in which the display unit is mounted on the vehicle.

[Appendix 12] The control device according to any one of [Appendix 1] to [Appendix 10], in which the display unit is an information terminal independent of the vehicle.

[Appendix 13] The control device according to any one of [Appendix 1] to [Appendix 12], in which the first information includes an estimated period required until the activation process is completed.

[Appendix 14] A control method for a display unit configured to display information on software update for an in-vehicle device mounted on a vehicle, the control method including causing the display unit to display first information and second information while an activation process for enabling update software installed in the in-vehicle device is being performed in response to switching of power of the vehicle from ON to OFF, the first information indicating progress of the activation process, the second information indicating that the power is not switchable from OFF to ON.

[Appendix 15] The control method according to [Appendix 14], in which the display unit is caused to display the first information and the second information in response to a start of the activation process.

[Appendix 16] The control method according to [Appendix 14] or [Appendix 15], in which the display unit is caused to display the first information and the second information in response to a predetermined operation by a user of the vehicle in which the activation process is being performed.

[Appendix 17] The control method according to any one of [Appendix 14] to [Appendix 16], in which the display unit is caused to display the second information in response to a start of the activation process, and the display unit is caused to display the first information in response to a predetermined operation by a user of the vehicle in which the activation process is being performed.

[Appendix 18] The control method according to any one of [Appendix 14] to [Appendix 17], in which the information displayed on the display unit is switched from the first information and the second information to third information in response to completion of the activation process, the third information indicating that the activation process has been completed.

[Appendix 19] The control method according to [Appendix 18], in which, when the activation process is performed for a plurality of the in-vehicle devices in response to the switching of the power of the vehicle from ON to OFF, the information displayed on the display unit is switched from the first information and the second information to the third information in response to completion of the activation process for all the in-vehicle devices.

[Appendix 20] The control method according to any one of [Appendix 14] to [Appendix 19], in which a process of displaying the first information and the second information on the display unit is performed by the in-vehicle device in which the activation process is performed.

[Appendix 21] The control method according to any one of [Appendix 14] to [Appendix 19], in which a process of displaying the first information and the second information on the display unit is performed by a control device mounted on the vehicle and different from the in-vehicle device in which the activation process is performed.

[Appendix 22] The control method according to any one of [Appendix 14] to [Appendix 19], in which a process of displaying the first information and the second information on the display unit is performed by a server device independent of the vehicle.

[Appendix 23] The control method according to any one of [Appendix 14] to [Appendix 22], in which the first information includes an estimated period required until the activation process is completed.

[Appendix 24] A program to be executed by a control device configured to control a display unit configured to display information on software update for an in-vehicle device mounted on a vehicle, the program causing the control device to perform a display process of causing the display unit to display first information and second information while an activation process for enabling update software installed in the in-vehicle device is being performed in response to switching of power of the vehicle from ON to OFF, the first information indicating progress of the activation process, the second information indicating that the power is not switchable from OFF to ON.

[Appendix 25] The program according to [Appendix 24], in which the display process is a process of causing the display unit to display the first information and the second information in response to a start of the activation process.

[Appendix 26] The program according to [Appendix 24] or [Appendix 25], in which the display process is a process of causing the display unit to display the first information and the second information in response to a predetermined operation by a user of the vehicle in which the activation process is being performed.

[Appendix 27] The program according to any one of [Appendix 24] to [Appendix 26], in which the display process is a process of causing the display unit to display the second information in response to a start of the activation process, and causing the display unit to display the first information in response to a predetermined operation by a user of the vehicle in which the activation process is being performed.

[Appendix 28] The program according to any one of [Appendix 24] to [Appendix 27], in which, in the display process, the control device is caused to perform a process of switching the information displayed on the display unit from the first information and the second information to third information in response to completion of the activation process, the third information indicating that the activation process has been completed.

[Appendix 29] The program according to [Appendix 28], in which, when the activation process is performed for a plurality of the in-vehicle devices in response to the switching of the power of the vehicle from ON to OFF, display is switched from the first information and the second information to the third information in response to completion of the activation process for all the in-vehicle devices.

[Appendix 30] The program according to [Appendix 28] or [Appendix 29], in which: the control device is one of the in-vehicle devices; and when the activation process is performed for a plurality of the in-vehicle devices including the control device in response to the switching of the power of the vehicle from ON to OFF, display is switched from the first information and the second information to the third information in response to completion of the activation process for all the in-vehicle devices.

[Appendix 31] The program according to any one of [Appendix 24] to [Appendix 30], in which the control device that executes the program is the in-vehicle device in which the activation process is performed.

[Appendix 32] The program according to any one of [Appendix 24] to [Appendix 30], in which the control device that executes the program is mounted on the vehicle, and is configured to cause the display unit to display the first information and the second information while the activation process is being performed for another of the in-vehicle devices mounted on the vehicle.

[Appendix 33] The program according to any one of [Appendix 24] to [Appendix 30], in which the program is executed by a server device independent of the vehicle.

[Appendix 34] The program according to any one of [Appendix 24] to [Appendix 32], in which the display unit is mounted on the vehicle.

[Appendix 35] The program according to any one of [Appendix 24] to [Appendix 33], in which the display unit is an information terminal independent of the vehicle.

[Appendix 36] The program according to any one of [Appendix 24] to [Appendix 35], in which the first information includes an estimated period required until the activation process is completed.

[Appendix 37] A non-transitory storage medium storing the program according to any one of [Appendix 24] to [Appendix 36].

What is claimed is:

1. A control device configured to control a display unit configured to display information on software update for an in-vehicle device mounted on a vehicle, the control device comprising a circuitry configured to cause the display unit to display first information and second information while an activation process for enabling update software installed in the in-vehicle device is being performed in response to switching of power of the vehicle from ON to OFF, the first information indicating progress of the activation process, the second information indicating that the power is not switchable from OFF to ON.

2. The control device according to claim 1, wherein the circuitry is configured to cause the display unit to display the first information and the second information in response to a start of the activation process.

3. The control device according to claim 1, wherein the circuitry is configured to cause the display unit to display the first information and the second information in response to a predetermined operation by a user of the vehicle in which the activation process is being performed.

4. The control device according to claim 1, wherein the circuitry is configured to cause the display unit to display the second information in response to a start of the activation process, and cause the display unit to display the first information in response to a predetermined operation by a user of the vehicle in which the activation process is being performed.

5. The control device according to claim 1, wherein the circuitry is configured to switch the information displayed on the display unit from the first information and the second information to third information in response to completion of the activation process, the third information indicating that the activation process has been completed.

6. The control device according to claim 5, wherein:
the vehicle includes a plurality of the in-vehicle devices; and
the circuitry is configured to, when the activation process is performed for the plurality of the in-vehicle devices in response to the switching of the power of the vehicle from ON to OFF, switch the information displayed on the display unit from the first information and the second information to the third information in response to completion of the activation process for all of the plurality of the in-vehicle devices.

7. The control device according to claim 5, wherein:
the vehicle includes a plurality of the in-vehicle devices;
the control device is one of the plurality of the in-vehicle devices; and
the circuitry is configured to, when the activation process is performed for the plurality of the in-vehicle devices including the control device in response to the switching of the power of the vehicle from ON to OFF, switch the information displayed on the display unit from the first information and the second information to the third information in response to completion of the activation process for all of the plurality of the in-vehicle devices including the control device.

8. The control device according to claim 1, wherein the control device is the in-vehicle device in which the activation process is performed.

9. The control device according to claim 1, wherein:
the control device is mounted on the vehicle; and
the circuitry is configured to cause the display unit to display the first information and the second information while the activation process is being performed for another of the in-vehicle devices mounted on the vehicle.

10. The control device according to claim 1, wherein the control device is a server device independent of the vehicle.

11. The control device according to claim 1, wherein the display unit is mounted on the vehicle.

12. The control device according to claim 1, wherein the display unit is an information terminal independent of the vehicle.

13. The control device according to claim 1, wherein the first information includes an estimated period required until the activation process is completed.

14. A control method for a display unit configured to display information on software update for an in-vehicle device mounted on a vehicle, the control method comprising causing the display unit to display first information and second information while an activation process for enabling update software installed in the in-vehicle device is being performed in response to switching of power of the vehicle from ON to OFF, the first information indicating progress of the activation process, the second information indicating that the power is not switchable from OFF to ON.

15. A non-transitory storage medium storing instructions that are executable by one or more processors and that cause the one or more processors to perform functions comprising:
controlling a display unit configured to display information on software update for an in-vehicle device mounted on a vehicle; and
performing a process of causing the display unit to display first information and second information while an activation process for enabling update software installed in the in-vehicle device is being performed in response to switching of power of the vehicle from ON to OFF, the first information indicating progress of the activation process, the second information indicating that the power is not switchable from OFF to ON.
